(19) United States
(12) Patent Application Publication
(10) Pub. No.: US 2016/0227107 A1
(43) Pub. Date: Aug. 4, 2016

(54) METHOD AND DEVICE FOR NOTIFICATION PREVIEW DISMISSAL

(71) Applicant: Lenovo (Singapore) Pte. Ltd., New Tech Park (SG)

(72) Inventor: Suzanne Marion Beaumont, Wake Forest, NC (US)

(21) Appl. No.: 14/611,446

(22) Filed: Feb. 2, 2015

(51) Int. Cl. H04N 5/232; G06F 3/00; G06F 3/01

(52) U.S. Cl. CPC H04N 5/23222; G06F 3/013; G06F 3/005; H04N 5/23229; H04N 5/23293

(57) ABSTRACT

Methods, devices and program products are provided for presenting a notification on a device, which includes a camera and a processor, detects a gaze event utilizing the camera and processor, and dismisses the notification based on the gaze event. The device comprises a processor and a display configured to present a notification. The device also comprises a camera configured to collect image frame data, and a local storage medium storing program instructions accessible by the processor. The processor, responsive to execution of the program instructions, detects a gaze event based on the image frame data and dismisses the notification based on the gaze event. The computer program product comprises a non-signal computer readable storage medium comprising computer executable code which presents a notification on a device, the device including a camera and a processor.

### BACKGROUND

Embodiments of the present disclosure generally relate to methods and devices for dismissing notifications presented on a device.

Currently, various types of devices offer notification previews to inform the user about certain information, such as receipt of a text message on a phone, an email on a computing device, an update to an application and the like. The notification previews are often fairly complete, thereby affording the user sufficient information about the text message, email, etc. to render it unnecessary for the user to access the underlying text message, email, etc., at the time of the notification preview. However, conventional devices repeatedly present the notification preview until the application related to the notification is opened and the content reviewed or the notification preview otherwise dismissed. As another example, when application updates are received for software applications, a count of the number of updates is presented next to one or more icons (e.g., the Application Store on a smartphone) to inform the user of the number of updates that are available for applications installed on the device. It is somewhat bothersome for the user to access each application or the “Application Store” to dismiss the update notifications.

Further, while increasing the content of the notification preview improves convenience to the user, excessive content within the notification preview may cause privacy concerns. Today, in accordance with conventional notification processes, the user has to step through a series of actions to dismiss a notification preview. While the series of actions are meant to assure that the content of the message is reviewed, accessing the complete content of the message becomes redundant and burdensome. Also, privacy concerns arise when the user has to complete an involve series of actions before dismissing the notification preview.

A need remains for methods and devices that afford notification preview dismissal that overcomes the foregoing and other disadvantages of conventional notification management approaches.

### SUMMARY

In accordance with an embodiment, a method is provided which presents a notification on a device. The device includes a camera and a processor, detects a gaze event utilizing the camera and processor, and dismisses the notification based on the gaze event. Optionally, the presenting includes displaying the notification on a display of the device while the device is in a restricted access mode. Alternatively, the method further comprises receiving notice-related data at the device, the notification including a preview regarding the notice-related data received.

Optionally, the method further comprises operating an application on the device, the notification representing a control feature associated with the application; and entering the control feature in response to the gaze event. Optionally, the detecting includes identifying gaze engagement representative of a gaze direction vector being directed at the device, and identifying a gaze termination representative of a gaze direction vector being directed away from the device.

Alternatively, the identifying includes capturing image frame data representing a user's face with the camera, detecting eye movement from the image frame data and calculating, utilizing the processor, the gaze direction vectors from the eye movement to identify the gaze engagement and gaze termination.

In accordance with an embodiment, a device is provided which comprises a processor and a display configured to present a notification. The device also comprises a camera configured to collect image frame data, and a local storage medium storing program instructions accessible by the processor. The processor, responsive to execution of the program instructions, detects a gaze event based on the image frame data and dismisses the notification based on the gaze event.

Optionally, the display displays the notification while the device is in a restricted access state. Alternatively, the camera captures image frame data representing a user's face, the processor analyzes the image frame data to detect eye movement and calculates gaze direction vectors from the eye movement to identify the gaze engagement and gaze termination.

In accordance with an embodiment, a computer program product is provided which comprises a non-signal computer readable storage medium comprising computer executable code. The computer executable code presents a notification on a device, the device including a camera and a processor. The computer executable code also detects, utilizing the camera and processor, a gaze event based on the image frame data captured by the camera. The computer executable code also dismisses the notification based on the gaze event.

### BRIEF DESCRIPTION OF THE DRAWINGS

FIG. 1 illustrates an overview of a device that may be held by a user proximate to a user face implemented in accordance with embodiments herein.

FIG. 2 illustrates a simplified block diagram of the device, which includes components such as one or more wireless transceivers, one or more processors, one or more local storage medium, the user interface which includes one or more input devices and one or more output devices, a power module, a digital camera unit, and a component interface, in accordance with embodiments herein.

FIG. 3 illustrates a process carried out in accordance with embodiments for dismissing preview notifications based on gaze events.

FIG. 4 illustrates a process for detecting a gaze event carried out in accordance with embodiments herein.

FIG. 5 illustrates a process for training the gaze detection process in accordance with embodiments herein.

FIGS. 6A-6B illustrate alternative embodiments in which the methods and devices described herein are implemented in connection with various types of devices in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The terms “communications content”, and “content,” as used throughout, shall generally refer to any and all textual, audio or video information or data conveyed to or from a device during a communications event. The content may represent various types of incoming and outgoing textual, audio, graphical and video content including, but not limited to, calendar updates, email, text messages, voicemail, incoming phone calls as well as other content in connection with social media and the like.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

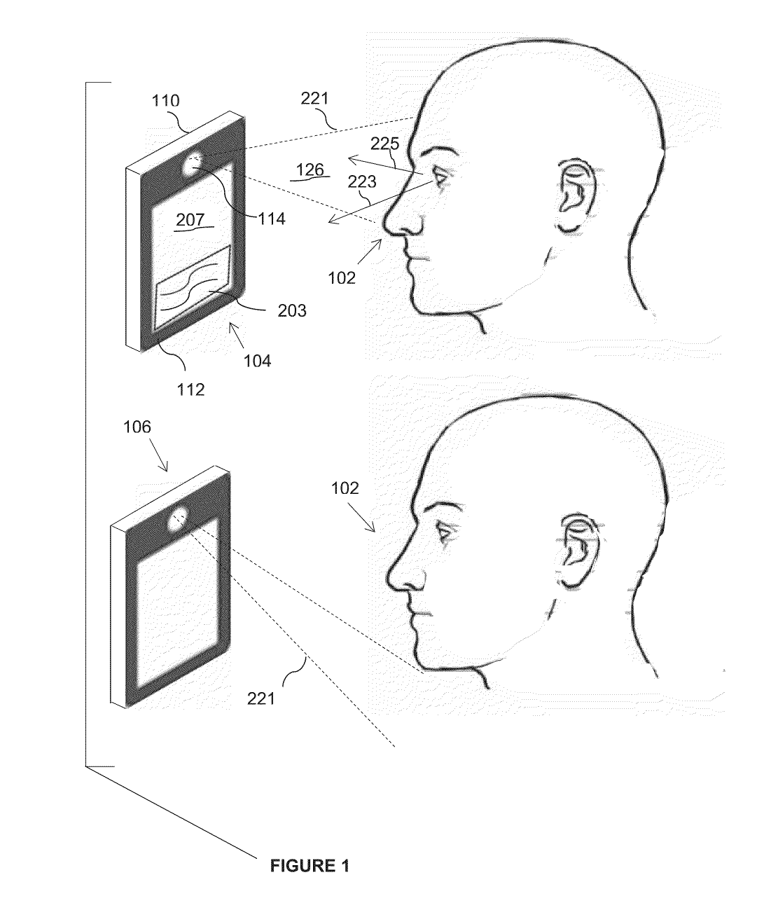

FIG. 1 illustrates an overview of a device implemented in accordance with embodiments herein. FIG. 1 illustrates a device 110 that may be held by a user proximate to a user face 102 such as when the user is engaged in viewing the display of the device 110 (generally referred to as engaged position 104). The device 110 may also be located remote from the user face 102, such as when the user is not viewing the display (generally referred to as disengaged position 106).

The device 110 includes a user interface 208 to display various types of information to the user and to receive inputs from the user. The user interface 208 presents a notification 203. The device 110 also includes a digital camera to take still and/or video images. The device 110 includes a housing 112 that includes at least one side, within which is mounted a lens 114 of the digital camera. The lens 114 is optically and communicatively coupled to a digital camera unit (as discussed herein in more detail). Optionally, the camera unit may represent another type of camera unit other than a digital camera. The lens 114 has a field of view 221 and operates under control of the digital camera unit in order to capture image data for a scene 126. When the device 110 is held in the engaged position 104, the user face 102 is located within the field of view 221. When the device is held in the disengaged position 106, the user face is located outside of the field of view 221.

Even when the user face 102 is located within the field of view 221, the user's eyes may be directed in various directs. For example, the user's eyes may be directed to have a line of sight as denoted by arrow 223, in which the user focuses on the user interface 208, and more particularly upon the notification 203 displayed within the user interface 208. As another example, the user's eyes may be directed away from the user interface 208 and notification 203, such as denoted by line of sight 225.

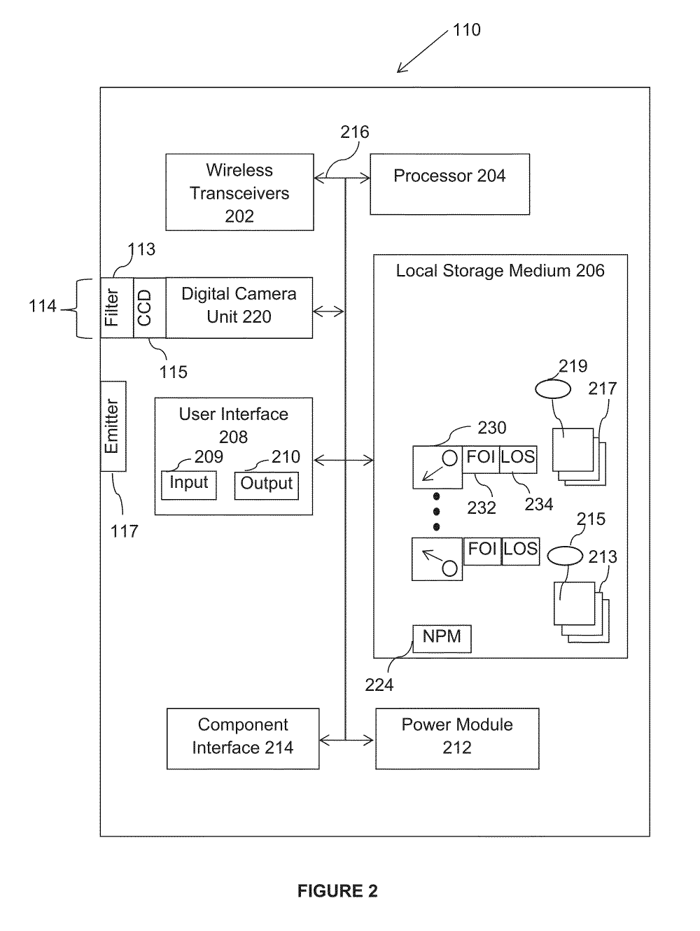

FIG. 2 illustrates a simplified block diagram of the device 110, which includes components such as one or more wireless transceivers 202, one or more processors 204 (e.g., a microprocessor, microcomputer, application-specific integrated circuit, etc.), one or more local storage medium (also referred to as a memory portion) 206, the user interface 208 which includes one or more input devices 209 and one or more output devices 210, a power module 212, a digital camera unit 220, and a component interface 214. All of these components can be operatively coupled to one another, and can be in communication with one another, by way of one or more internal communication links 216, such as an internal bus.

The housing 112 of the device 110 holds the processor(s) 204, local storage medium 206, user interface 208, the digital camera unit 220 and other components. The lens 114 is optically and communicatively coupled to the digital camera unit 220. The lens 114 is mounted in the bezel along the perimeter of the user interface 208. Optionally, multiple lenses 114 may be positioned at various distributed positions within, or about the perimeter of, the user interface 208, and/or elsewhere in the housing 112. The digital camera unit 220 may represent various types of cameras, detection units and the like. The digital camera unit 220 may further include one or more filters 113 and one or more detectors 115, such as a charge coupled device (CCD). The detector may be coupled to a local processor within the digital camera unit 220 that analyzes image frame data captured. The digital camera unit 220 may include one or multiple combinations of emitters, detectors and lens. For example, an array of two or more detector/lens combinations may be spaced apart from one another on the housing 112. When multiple detectors/lens are used, each detector/lens combination may be oriented in at least partially different directions, such that the fields of view of the respective detector/lens combinations encompass different areas. One or more emitters 117 may be provided within or separate from the lens 114 and detector 115.

For example, the digital camera unit 220 may represent one or more infrared (IR) light emitting diode (LED) based-camera devices. For example, one or more IR-LED emitters 117 may be used to illuminate the field of view with one or more select wavelengths of light (e.g., 880 nm). A high pass filter (HPF) 113 element is located with the lens 114 such that the HPF 113 element passes infrared light with a select wavelength (e.g., 800 nm). By using an IR-LED with the select one or more wavelengths, the image frames captures by the detector 115 are not affected by the IR-LED light. The lens 114 has a field of view 221 and operates under control of the digital camera unit 220 in order to capture image data frames for a scene 126. The image data frames may represent still images and/or video images.

The input and output devices 209, 210 may each include a variety of visual, audio, and/or mechanical devices. For example, the input devices 209 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 210 can include a visual output device such as a liquid crystal display screen, one or more light emitting diode indicators, an audio output device such as a speaker, alarm and/or buzzer, and a mechanical output device such as a vibrating mechanism. The display may be touch sensitive to various types of touch and gestures. As further examples, the output device(s) 210 may include a touch sensitive screen, a non-touch sensitive screen, a text-only display, a smart phone display, an audio output (e.g., a speaker or headphone jack), and/or any combination thereof. The user interface 208 permits the user to select one or more of a switch, button or icon in connection with normal operation of the device 110.

The local storage medium 206 may encompass one or more memory devices of any of a variety of forms (e.g., read only memory, random access memory, static random access memory, dynamic random access memory, etc.) and can be used by the processor 204 to store and retrieve data. The data that is stored by the local storage medium 206 can include, but need not be limited to, operating systems, applications, user collected content and informational data. Each operating system includes executable code that controls basic functions of the communication device, such as interaction among the various components, communication with external devices via the wireless transceivers 202 and/or the component interface 214, and storage and retrieval of applications and data to and from the local storage medium 206. Each application includes executable code that utilizes an operating system to provide more specific functionality for the communication devices, such as file system service and handling of protected and unprotected data stored in the local storage medium 206.

As explained herein, the local storage medium 206 stores various content, including but not limited to image data frames 230, feature of interest (FOI) position data 232, line of sight (LOS) data 234 and the like. The local storage medium 206 also stores updates 213 and content 217. The updates 213 may correspond to status information regarding the device 110 (e.g. battery status), updates for the device 110, updates for applications saved on the device 110, and the like. The content 217 may represent various types of incoming and outgoing textual, audio, graphical and video content including, but not limited to, calendar updates, email, text messages, voicemail, incoming phone calls as well as other content in connection with social media and the like.

When an update 213 is received, the processor 204 generates an update related notification 215. When content 217 is received, the processor 204 generates a content related notification 219. As explained herein, the notifications 215 and 219 are presented on the display of the device 110 and are dismissed in accordance with embodiments herein based upon detection of gaze events.

Other applications stored in the local storage medium 206 include various application program interfaces (APIs). Additionally, the applications stored in the local storage medium 206 include a notification preview management (NPM) application 224 for facilitating the management of notifications on the device 110 to allow a user to read a notification and dismiss the notification without requiring the user to manually touch the user interface or physically enter a series of inputs to the device 110. The NPM application 224 is preferably activated by default upon start-up of the device 110, and can be activated or disabled via input devices 209 of the user interface 208. In one embodiment, the NPM application 224 may be activated when the device 110 is placed in a predetermined state (e.g., when entering the lock screen state). The NPM application 224 includes program instructions accessible by the processor 204 to direct the processor 204 to implement the methods, processes and operations described herein, and illustrated and described in connection with the Figures.

In accordance with embodiments herein, the NPM application 224 analyzes the image frame data 230 captured by the digital camera unit 220 to detect facial features, eye movement, line of sight of the eyes and the like. In accordance with embodiments herein, the digital camera unit 220 collects a series of image data frames 230 associated with the scene 126 over a select period of time. For example, the digital camera unit 220 may begin capturing the image data frames 230 when a notification is presented on the display, and continue capturing for a predetermined period of time. As another example, the digital camera unit 220 may begin to capture the image data frames 230 when the application 224 senses movement of the device 110 (e.g. in accordance with a user picking up and holding the device 110 proximate the user face). Image frame data 230 may be collected for a predetermined period of time, for a select number of frames or based on other data collection criteria.

The processor 204, under control of the application 224, analyzes one or more image data frames 230, to detect a position of one or more features of interest (e.g. nose, mouth, eyes, glasses, eyebrows, hairline, cheek bones) within the image data frames 230. The positions of the features of interest are determined from the image data frames, where the position is designated with respect to a coordinate reference system (e.g. an XYZ reference point in the scene, or with respect to an origin on the face). The processor 204 records, in the local storage medium 206, FOI position data 232 indicating a location of each feature of interest, such as relative to a reference point within an individual image data frame 230. The FOI position data 232 may include additional information regarding the feature of interest (e.g. left eye, whether the user is wearing glasses, right eye, whether the user has sunglasses, etc.).

The processor 204, under the control of the application 224, also determines the line of sight associated with one or more eyes that represent features of interest, and generates LOS data 234 based thereon. The LOS data 234 may represent a gaze direction vector defined with respect to a coordinate system. For example, the gaze direction vector may be defined with respect to a polar coordinate system, where a reference point and origin of the polar coordinate system are located at a known position such as a surface of the eye for which the line of sight is determined. The LOS data 234 may represent a direction, but defined with respect to a non-polar coordinate system, or defined with respect to a coordinate system having a reference point that is separate from the eye representing the feature of interest, or defined without regard to a coordinate system. For example, the LOS data 234 may indicate general directions, such as straight ahead, down, left, right, up, etc. The LOS data 234 is saved in the local storage medium 206 in combination with the FOI position data 232 and corresponding image data frames 230.

The power module 212 preferably includes a power supply, such as a battery, for providing power to the other components while enabling the device 110 to be portable, as well as circuitry providing for the battery to be recharged. The component interface 214 provides a direct connection to other devices, auxiliary components, or accessories for additional or enhanced functionality, and in particular, can include a USB port for linking to a user device with a USB cable.

Each transceiver 202 can utilize a known wireless technology for communication. Exemplary operation of the wireless transceivers 202 in conjunction with other components of the device 110 may take a variety of forms and may include, for example, operation in which, upon reception of wireless signals, the components of device 110 detect communication signals and the transceiver 202 demodulates the communication signals to recover incoming information, such as voice and/or data, transmitted by the wireless signals. After receiving the incoming information from the transceiver 202, the processor 204 formats the incoming information for the one or more output devices 210. Likewise, for transmission of wireless signals, the processor 204 formats outgoing information, which may or may not be activated by the input devices 209, and conveys the outgoing information to one or more of the wireless transceivers 202 for modulation to communication signals. The wireless transceiver(s) 202 convey the modulated signals to a remote device, such as a cell tower or a remote server (not shown).

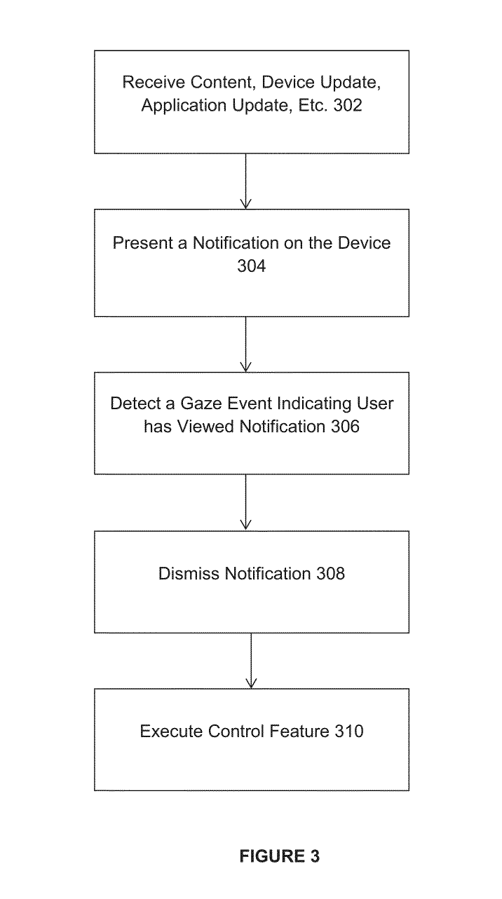

FIG. 3 illustrates a process carried out in accordance with embodiments for dismissing preview notifications based on gaze events. The operations of FIG. 3 are carried out by one or more processors 204 of the device 110 in response to execution of program instructions, such as in the NPM application 224, and/or other applications stored in the local storage medium 206.

At 302, the method receives incoming notice-related data, such as communications content, a device update, an application update, or other information warranting a notification to the user. For example, the incoming communications content may represent a phone call, a voicemail, a text message, an email message, or any other type of information related to a social media. A device update may represent device status related information (e.g. remaining battery life, remaining storage) and the like. Examples of application updates include updates to a device operating system or any software and/or firmware application running on the device.

At 304, a notification is presented on the device to the user. For example, the notification may represent a pop-up window displayed on a display of the device with text, images or other information therein related to the incoming notice related data. The notification may include a portion of text within an incoming email, text message, etc. the notification may include a thumbnail image from an incoming document, image or video. As one example, the notification may be presented on a touch screen of a smart phone, tablet, computer, appliance, equipment, etc. while the device is in a restricted access state, also referred to as a locked screen state. For example, when a user does not access a smart phone, table, computer, etc. for a select period of time, the device enters a restricted access mode. When in a restricted access mode, the user may need to enter a password or take another action to unlock the screen or otherwise gain full access to the functionality of the device. In accordance with embodiments herein, the notification may be presented to the user while the device is in a restricted access mode or while the device is in a full access mode (with no restrictions).

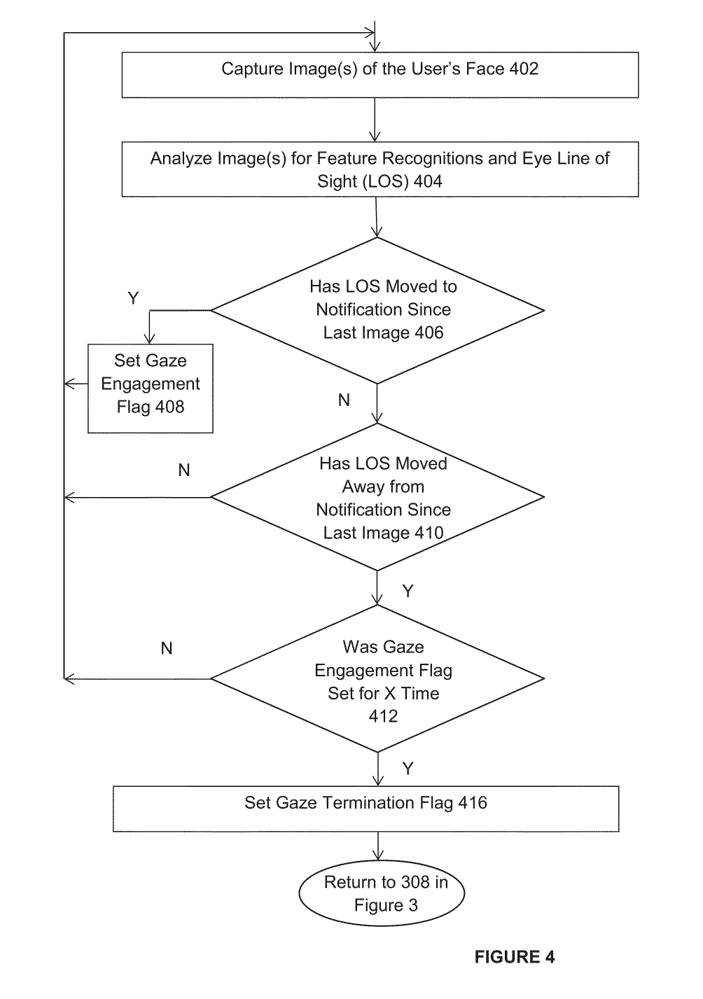

At 306, the method detects a gaze event indicating that a user has reviewed the notification. For example, the method utilizes the digital camera unit to capture still or video images, and uses the processor to analyze the still or video images, as explained herein in connection with FIG. 4, to identify when a user begins to initially look at the notification (referred to as gaze engagement) and when a user looks away from the notification (referred to as gaze termination).

Optionally, gaze event detection may be combined with additional inputs from the user. For example, at 306, the method may, in addition to detecting a gaze event, also determine when the user enters one or more predefined touch gestures through the user interface and/or voice commands through a microphone on the device 110. The predefined touch gestures and/or voice command may provide additional information, such as regarding execution of control features (as discussed below in connection with 310).

At 308, the method dismisses the notification. For example, a notification pop-up window presented on the display of the device may be removed. When device settings are set such that reminder notifications are to be repeated, the dismissal of the notification includes canceling future reminder notifications. Optionally, when the notification relates to a software or device update, the dismissal includes cancelling a count associated with the update that would otherwise be shown on the display next to an application icon. For example, a smartphone may display a numeric count of application updates next to an “Application Store” icon. When the method dismisses an update related notification through gaze event detection (as described herein), the count of updates for the Application Store is decreased (or not increased) for the corresponding update and notification.

Optionally, in connection with certain types of incoming content and update, the method may also process a receipt acknowledgment. The receipt acknowledgment is conveyed to a source of the incoming content or update.

At 310, the method may include an optional operation execution in which the method executes one or more control features associated with the notification. For example, in some embodiments, the device may be operating an application, such as playing music, recording audio/video, providing navigation and the like. The notification may illustrate one or more control features associated with the application. In some embodiments, a gaze event may be associated with selecting one or more of the control features. For example, when playing music, the control features may represent play/pause, skip/backwards, volume, etc. When the user gazes at the notification for a predetermined period of time, the device may skip to the next song. When the notification relates to a navigation instruction and the user gazes at the notification for a predetermined period of time, the gaze event may be associated with repeating an audio navigation instruction and the like. Optionally, the execution operation at 310 may be omitted entirely.

Optionally, the execution operation at 310 may be performed in response to detection of a combination of a gaze event and an additional user input (e.g. a touch gesture and/or voice command). For example, when the notification concerns operation of a music application, while the user gazes at the notification, the user may provide a predefined touch gesture and/or an voice instruction, such as to “skip song”, “increase/decrease the volume”, “pause”, “play”, etc. As another example, when the notification concerns operation of a navigation application, while the user gazes at the notification, the user may provide a predetermined touch gesture and/or a voice instruction, such as “repeat instruction”, “which way do I turn”, “which intersection do I turn”, “how far to the next turn”, etc.

FIG. 4 illustrates a process carried out in accordance with an embodiment for detecting a gaze event. The operations of FIG. 4 are carried out by one or more processors 204 of the device 110 in response to execution of program instructions in the NPM application 224 and/or other applications stored in the local storage medium 206 or elsewhere. At 402, image frame data is captured by the digital camera unit 220. The image frame data corresponds to one or more images of a region directly in front of the display 207 for the device 110 (e.g., the scene 126 in the field of view 221 in FIG. 1). Accordingly, when the user holds the device 110 in a position where the user can view the display 207, the digital camera unit 220 captures image data frames of the user's face appearing within the field of view 221. The image frame data captured at 402 may represent a single still image, a series of still images, and/or one or more video segments.

At 404, the method analyzes the image frame data captured at 402. In accordance with some embodiments, the analysis at 404 may perform feature recognition of one or more features of interest (e.g., eye center, eye corner, nostrils, mouth corner, etc.) from one or more images of the face of the user. As one example, the IR-LED emitter 117 and IR detector 115 may be used to capture specular reflection in order to detect the FOI of the eyes. For example, the FOI may correspond to the eye centers, eye corners, nostrils, lip corners and/or other facial features readily recognizable through feature recognition. When a user gazes at a notification 203, the method may compute the three dimensional (3D) position features based on 3D rotation and translation estimation and affine transforms.

At 404, the method detects eye movement from the images and calculates gaze positions from the eye movement. For example, the method may determine the gaze position based on the line of sight associated with the eyes. As one example, the method may use a neural network to detect the gaze position by eye movement. For example, the method may determine whether the user's eyes are directed at the display screen or directed in another direction. The feature recognition information and line of sight associated with the eyes are saved in connection with the present image or images, such as for comparison with earlier and later images as explained herein. The line of sight information is used to define one or more gaze direction vectors corresponding to a direction in which the user is looking.

At 406, the method compared a current image or images with a prior image or images within the image frame data to determine differences in the eye line of sight (or gaze direction vectors) between current and prior images. For example, the method may compare the gaze direction vectors associated with a series of image data frames and identify differences there between. Based on the differences in the gaze direction vectors (or more generally the eye LOS), the method determines whether the line of sight of the user's eyes has moved, within the series of image data frames analyzed, from a remote focal point (e.g., not focused on the notification) to a notification focal point (e.g., focused on the notification). When the method determines that the line of sight has moved to the notification and thus, the user is now directing his/her attention on the notification, flow advances to 408. Otherwise, flow skips to 410.

At 408, the method sets a gaze engagement flag indicating that the user is now viewing the notification. Optionally, a timestamp may be saved with the gaze engagement flag to indicate when the gaze engagement flag was set. Optionally, additional information regarding the facial features, gaze direction vector and/or LOS may be saved with the gaze engagement flag. Thereafter, flow returns to 402 to capture more image frame data.

At 410, the method compares the series of image data frames with one another to determine differences in the line of sight. For example, the method may compare the gaze direction vectors associated with a series of image data frames and identify differences there between. Based on the differences in the gaze direction vectors (or more generally the eye LOS), the method determines whether the line of the site of the user's eyes has moved from a notification focal point (e.g., directed at the notification) to a remote focal point (e.g., not directed at the notification). When it is determined that the line of sight was directed at the notification in prior images, but has now moved (in current images) to a focal point remote from the notification, flow advances to 412. Otherwise, flow returns to 402 (as the user is still looking at the notification).

At 412, the method determines whether the gaze engagement flag is presently set and has been set for a select period of time (e.g., a period of time sufficient to read the notification). The operation at 412 is performed as a check or confirmation that a valid gaze event did in fact occur. For example, an invalid gaze event may occur, such as when the user glances at the display (e.g., for some other reason) for a very short period of time, not sufficient to read or otherwise assess the notification. As another example, the device 110 may be moved in a manner that the field of view 221 passes the users' face inadvertently, even though the user is not viewing the notification. Accordingly, the decision at 412 assesses whether the user's gaze has been directed at, and held on, the notification for the select period of time as a confirmation that the gaze event is valid.

At 412, when the method determines that the gaze engagement flag has not been set for a sufficient period of time, flow returns to 402 where additional image frame data is captures. When the decision at 412 indicates that the gaze engagement flag has been set for the select period of time, flow moves to 416. Optionally, the confirmation check at 412 may be omitted.

At 416, the method sets a gaze termination flag indicating that the gaze direction vector is not directed at the notification. Optionally, a timestamp may be saved with the gaze termination flag to indicate when the gaze termination flag was set. Optionally, additional information regarding the facial features and LOS may be saved with the gaze termination flag.

The operations at 402-416 may be repeated multiple times until the method identifies a valid gaze event as defined by a gaze engagement flag followed by a gaze termination flag after a select period of time. Upon completion of the process of FIG. 4, flow returns to the operations at 308 in FIG. 3.

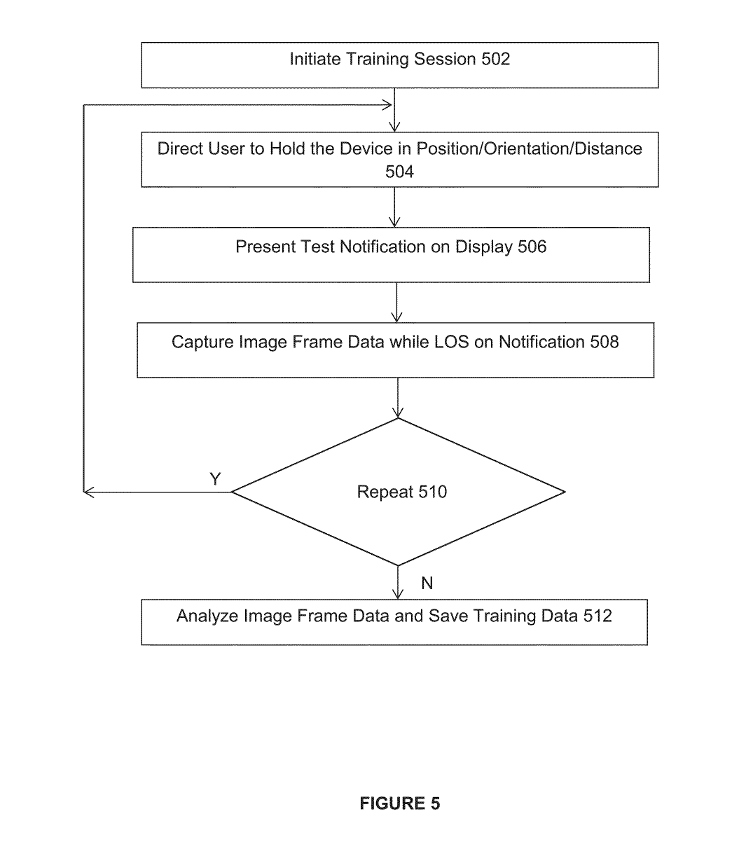

FIG. 5 illustrates a process carried out in accordance with an embodiment for training the gaze detection process. The operations of FIG. 5 are carried out by one or more processors 204 of the device 110 in response to execution of program instructions in the NPM application 224 and/or other applications stored in the local storage medium 206 or elsewhere. At 502, the method initiates a training session. For example, the training session may be initiated by setting the device 110 in a training mode, determining instructions regarding how to implement a training session and the like.

At 504, the method provides directions (e.g. through audio, video or text on the device) for the user to hold the device in a select position and/or orientation, as well as a select distance from the user face. At 506, the method presents a test notification to the user on the display of the device. The test notification may represent a mocked up notification that includes test content and/or a test update. The test notification is presented at a location on the display 207 at which standard notifications will be presented. The method instructs the user to view the test notification while holding the device at the select position, orientation and/or distance from the user face.

At 508, the method captures a series of image frame data while the user is viewing the notification. At 510, the method determines whether additional image frame data is desired, such as when the user is holding the device in the same or a different position, orientation and/or distance. When additional image frame data is desired at alternative positions, orientations and distances, flow returns to 504. At 504, the method provides updated instructions to the user regarding how to hold the device in a different position, orientation and/or distance. Thereafter, the operations at 506-510 are repeated a desired number of times until capturing a sufficient amount of image frame data representative of various potential scenarios in which the user holds the device while viewing notifications. When a sufficient amount of image frame data is captured, flow moves to 512.

At 512, the method analyzes the image frame data to derive information concerning various lines of sight, gaze direction vectors, facial features of interest and the like. The information produced at 512 is saved (e.g. in the local storage medium 206), such as in a user profile, to be accessed during operation by the present user in connection with the operations of FIGS. 3 and 4 when identifying gaze events.

The device may broadly encompass any type of system or device, on which a notification is presented and dismissed based on gaze events. The device may represent a computing device, an electronic device, equipment or other non-computing device, etc. The device may represent a computer, tablet, phone, smart watch and the like. The foregoing examples, describe the device application in connection with applications operating on a portable device, although the present disclosure is not limited to such applications. Instead, the device may be useful in various other applications, such as within an automobile, an airplanes, a home or commercial appliance, home or industrial equipment, etc.

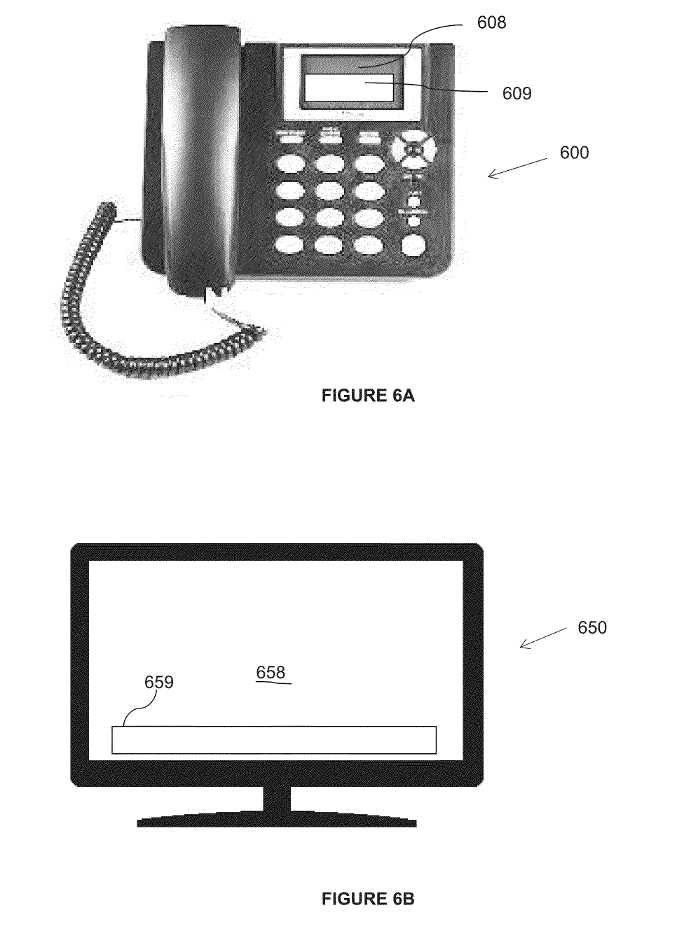

FIGS. 6A-6B illustrate alternative embodiments in which the methods and devices described herein are implemented in connection with various types of devices. For example, as illustrated in connection with FIG. 6A, the device 600 may represent a desk or tabletop phone, other than a smart phone, such as in a home or office environment. The phone includes a display 608 that may present various information to the user. For example, when receiving an incoming call, the phone display may present a notification 609 representing caller ID to inform the user regarding the source of the incoming call. As another example, when the user is on a phone call, and another call comes in, the display 608 may present a notification 609 regarding the second incoming call.

A camera unit is provided within the housing of the phone or alternatively as a separate stand-alone unit that is communicatively coupled to the phone. The camera unit detects gaze events as explained herein and communicates with a controller or processor within the phone to dismiss the notification. As a further example, the notification may represent an audible sound, such as the phone ringing, that is dismissed when the user completes a gaze event, such as directing the user's line of sight at the phone display or at a lens of a camera unit located on the phone or near the phone.

As another example, as illustrated in connection with FIG. 6B, the device 650 may represent a television or other audio/visual electronic device. The television may present notifications 659 in a select portion of the display 658. For example, the notification 659 may represent an adverse weather update, school cancellations, an incoming phone call, etc., where the notification 659 is presented in a corner of the display 658 or along a top or bottom margin or elsewhere while the user views a program in the main portion of the display. A camera unit is provided within the housing of the television or alternatively as a separate stand-alone unit. The camera unit may be positioned proximate to the area on the television where the notifications are to be presented. The camera unit is communicatively coupled to the television. The camera unit detects gaze events as explained herein and communicates with a controller or processor within the television to dismiss the notification.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A method, comprising:
presenting, using a processor, a notification on a device;
detecting a gaze event utilizing a camera and processor of the device; and
dismissing the notification based on the gaze event.

2. The method of claim 1, wherein the presenting includes displaying the notification on a display of the device while the device is in a restricted access mode.

3. The method of claim 1, further comprising receiving notice-related data at the device, the notification including a preview regarding the notice-related data received.

4. The method of claim 1, further comprising:
operating an application on the device, the notification representing a control feature associated with the application; and
entering the control feature in response to the gaze event.

5. The method of claim 1, wherein the detecting includes identifying gaze engagement representative of a gaze direction vector being directed at the device, and identifying a gaze termination representative of a gaze direction vector being directed away from the device.

6. The method of claim 5, wherein the identifying includes:
capturing image frame data representing a user's face with the camera;
detecting eye movement from the image frame data; and
calculating, utilizing the processor, the gaze direction vectors from the eye movement to identify the gaze engagement and gaze termination.

7. The method of claim 1, wherein the dismissing includes processing a receipt acknowledgement in connection with the notification.

8. A device, comprising:
a processor;
a display to present a notification;
a camera to collect image frame data;
a local storage medium storing program instructions accessible by the processor;
wherein, responsive to execution of the program instructions, the processor:
detects a gaze event based on the image frame data; and
dismisses the notification based on the gaze event.

9. The device of claim 8, wherein the display displays the notification while the device is in a restricted access state.

10. The device of claim 8, wherein the processor receives content, the display displaying, as the notification, a notification preview including a portion of the content.

11. The device of claim 8, wherein the processor operates an application on the device, the display presenting, within the notification, a control feature associated with the application, the processor entering the control feature in response to the gaze event.

12. The device of claim 8, wherein the processor identifies a gaze engagement representative of a gaze direction vector being directed at the device, and identifies a gaze termination representative of a gaze direction vector being directed away from the device, the gaze engagement and gaze termination defining the gaze event.

13. The device of claim 12, wherein the camera captures image frame data representing a user's face, the processor analyzes the image frame data to detect eye movement and calculates gaze direction vectors from the eye movement to identify the gaze engagement and gaze termination.

14. The device of claim 8, wherein the processor processes a receipt acknowledgement in connection with the notification.

15. The device of claim 8, wherein the local storage medium stores a series of image data frames associated with scenes that appear in a field of view of the camera over time, and feature of interest (FOI) position data indicating a location of a feature of interest in the corresponding image data frames, the processor calculating gaze direction vectors based on the FOI position data.

16. The device of claim 8, wherein the camera collects a series of image data frames associated with scenes that appear in a field of view of the camera over time when a notification is presented on the display and continuing for a predetermined period of time.

17. A computer program product comprising a non-signal computer readable storage medium comprising computer executable code to perform:
presenting a notification on a device, the device including a camera and a processor;
detecting, utilizing the camera and processor, a gaze event based on the image frame data captured by the camera; and
dismissing the notification based on the gaze event.

18. The computer program product of claim 17, further comprising code to perform analysis of images captured by the camera to detect a line of sight of eyes of a user face in a field of view of the camera.

19. The computer program product of claim 17, wherein the receiving operation includes one or more of:
analyze image data frames to determine a line of sight of a user in connection with the image data frames;
determine changes in the line of sight from a first direction that excludes the notification to a second direction that includes the notification; and
set a gaze engagement flag indicating that the line of site has changed to the second direction that includes the notification.

20. The computer program product of claim 17, further comprising code to:
analyze image data frames to determine a line of sight of a user in connection with the image data frames;
determine changes in the line of the site from a first direction that includes the notification to a second direction that excludes the notification; and
set a gaze termination flag indicating that the line of site has changed to the second direction that excludes the notification.
